(19) United States
(12) Patent Application Publication
(10) Pub. No.: US 2015/0053736 A1
(43) Pub. Date: Feb. 26, 2015

(54) PNEUMATIC FASTENER DRIVER

(71) Applicant: Techtronic Power Tools Technology Limited, Tortola (VG)

(72) Inventors: Edward A. Pomeroy, Piedmont, SC (US); John Schnell, Anderson, SC (US)

(73) Assignee: Techtronic Power Tools Technology Limited, Tortola (VG)

(21) Appl. No.: 13/973,576

(22) Filed: Aug. 22, 2013

(51) Int. Cl. B25C 1/04; B25C 5/13

(52) U.S. Cl. CPC B25C 1/041; B25C 5/13; B25C 1/047
USPC 227/142; 227/156

(57) ABSTRACT

The invention provides, in one aspect, a pneumatic fastener driver including a cylinder and a piston positioned within the cylinder. The piston is moveable between a top-dead-center position and a bottom-dead-center position. The driver also includes a magnetic latch emitting a magnetic field that magnetically attracts the piston and is capable of holding the piston in the top-dead-center position with a magnetic force. The magnetic latch is adjustable to vary the magnetic force acting on the piston for driving fasteners into a workpiece at different depths.

### FIELD OF THE INVENTION

The present invention relates to a pneumatic fastener driver.

### BACKGROUND OF THE INVENTION

There are various fastener drivers used to drive fasteners (e.g., nails, tacks, staples, etc.) into a workpiece known in the art. These fastener drivers operate utilizing various means (e.g., compressed air generated by an air compressor, electrical energy, flywheel mechanisms) known in the art, but often these designs are met with power, size, and cost constraints.

### SUMMARY OF THE INVENTION

The invention provides, in one aspect, a pneumatic fastener driver including a cylinder and a piston positioned within the cylinder. The piston is moveable between a top-dead-center position and a bottom-dead-center position. The driver also includes a magnetic latch emitting a magnetic field that magnetically attracts the piston and is capable of holding the piston in the top-dead-center position with a magnetic force. The magnetic latch is adjustable to vary the magnetic force acting on the piston for driving fasteners into a workpiece at different depths.

The invention provides, in another aspect, a pneumatic fastener driver including a housing, a cylinder positioned within the housing, a piston positioned within the cylinder that is movable between a top-dead-center position and a bottom-dead-center position, and a cylinder head integrally formed at a first end of the cylinder as a single component.

The invention provides, in yet another aspect, a pneumatic fastener driver including a first cylinder, a first piston positioned within the first cylinder, a second cylinder positioned within the first cylinder, a second piston positioned within the second cylinder, and means for positioning the second cylinder relative to the first cylinder.

Other aspects of the invention will become apparent by consideration of the detailed description and accompanying drawings.

### BRIEF DESCRIPTION OF THE DRAWINGS

FIG. 1 is a perspective view of a pneumatic fastener driver in accordance with an embodiment of the invention.

FIG. 2A is a partial cross-sectional view of the pneumatic fastener driver of FIG. 1 taken along line 2A-2A in FIG. 1.

FIG. 2B is an enlarged, partial cross-sectional view of the pneumatic fastener driver of FIG. 2A illustrating an upward stroke of a compression piston.

FIG. 2C is an enlarged, partial cross-sectional view of the pneumatic fastener driver of FIG. 2A illustrating a downward stroke of a driver piston.

FIG. 2D is an enlarged, partial cross-sectional view of the pneumatic fastener driver of FIG. 2A illustrating an upward stroke of the driver piston.

FIG. 3A is an enlarged, cross-sectional view of the pneumatic fastener driver of FIG. 2A illustrating a magnetic latch in a first position.

FIG. 3B is an enlarged, cross-sectional view of the pneumatic fastener driver of FIG. 2A illustrating the magnetic latch in a second position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

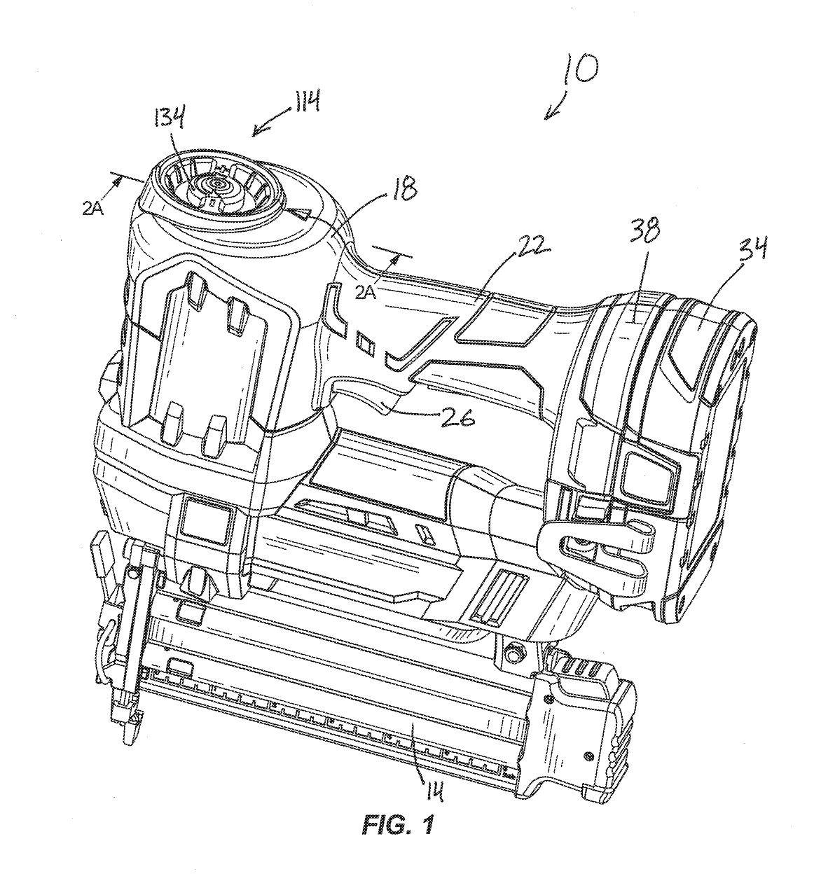

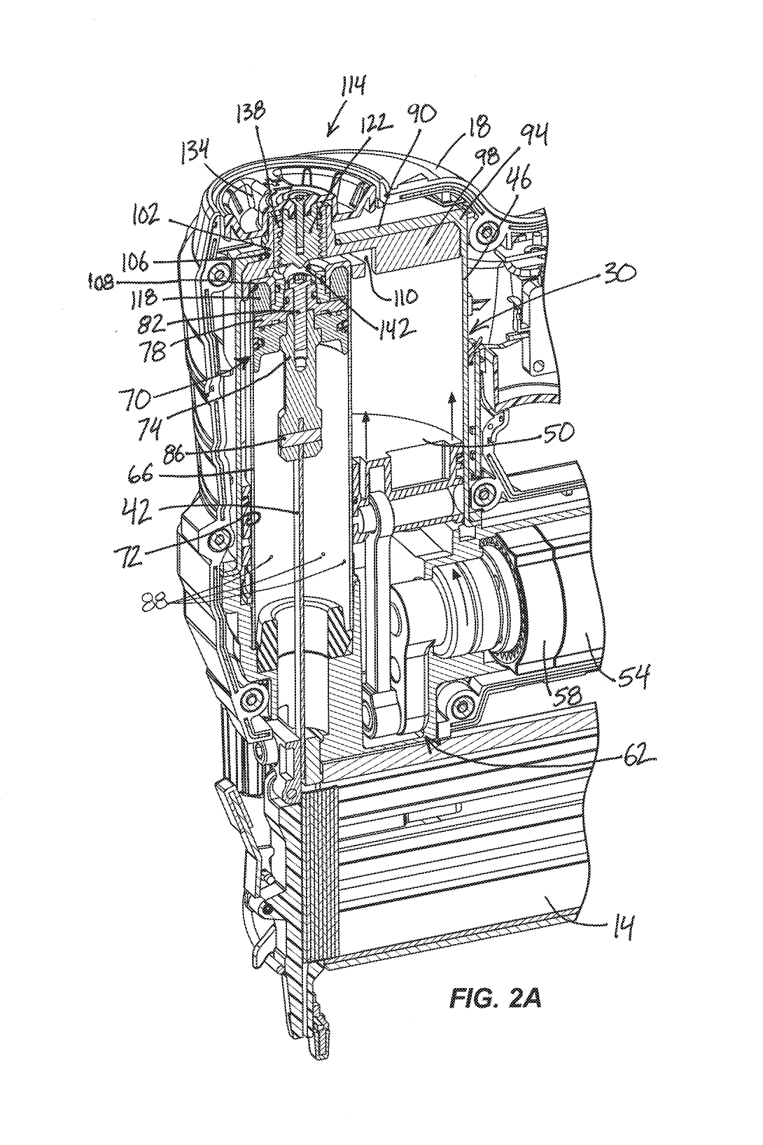

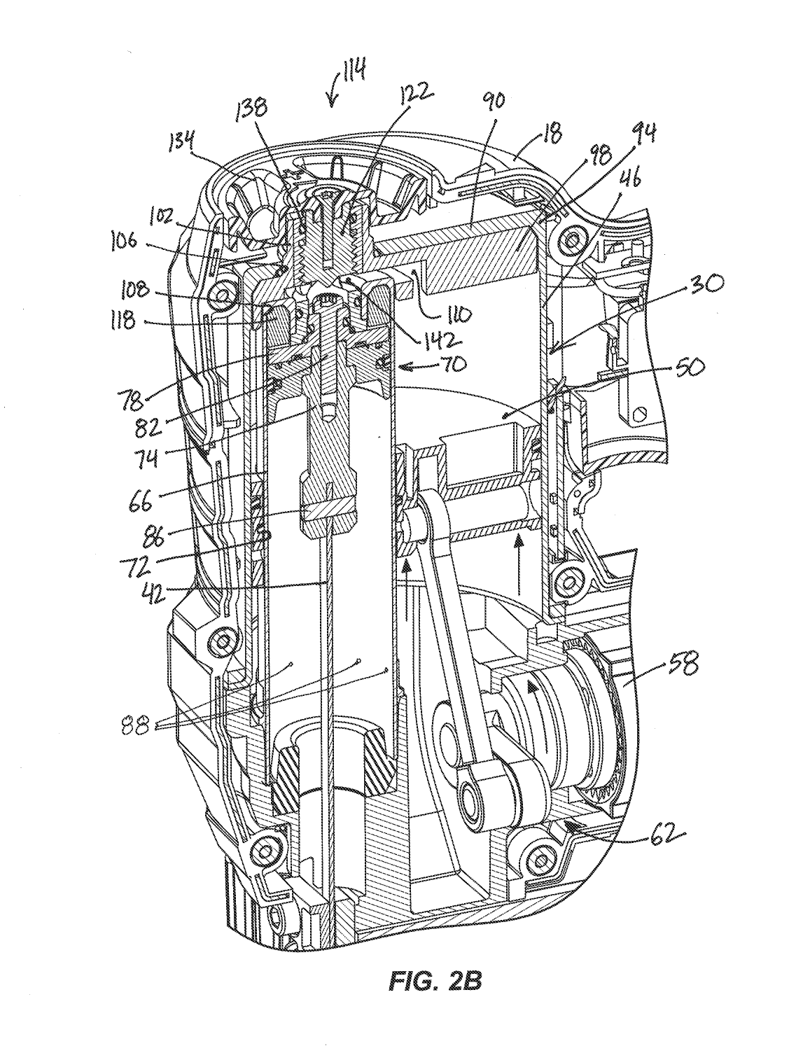

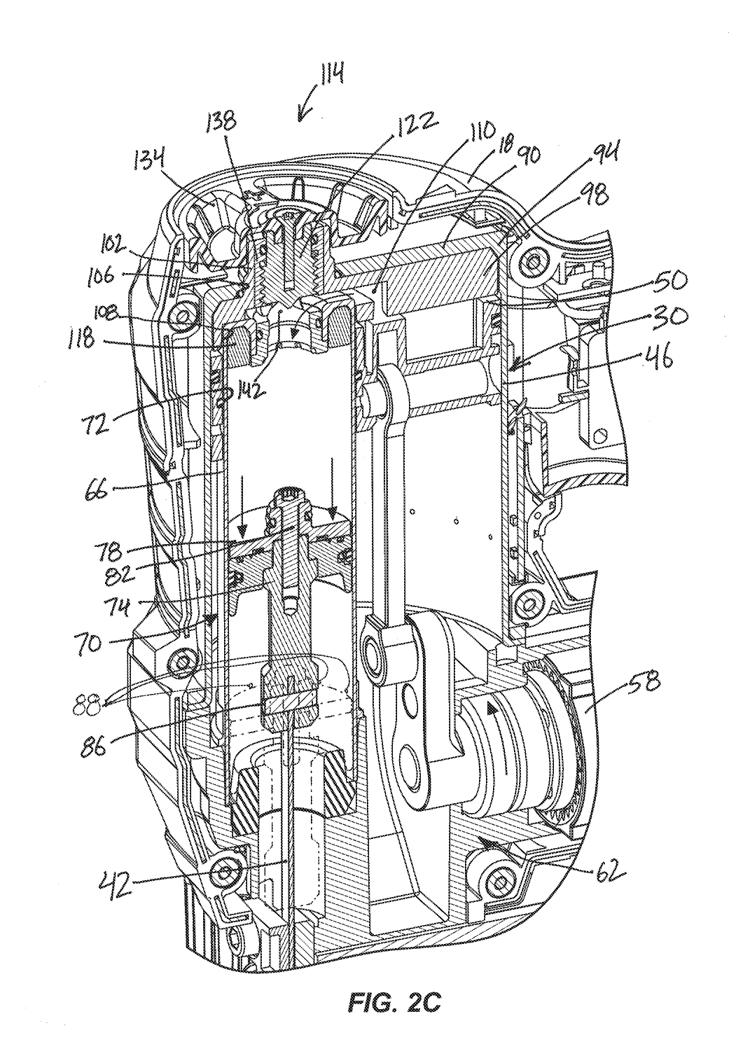

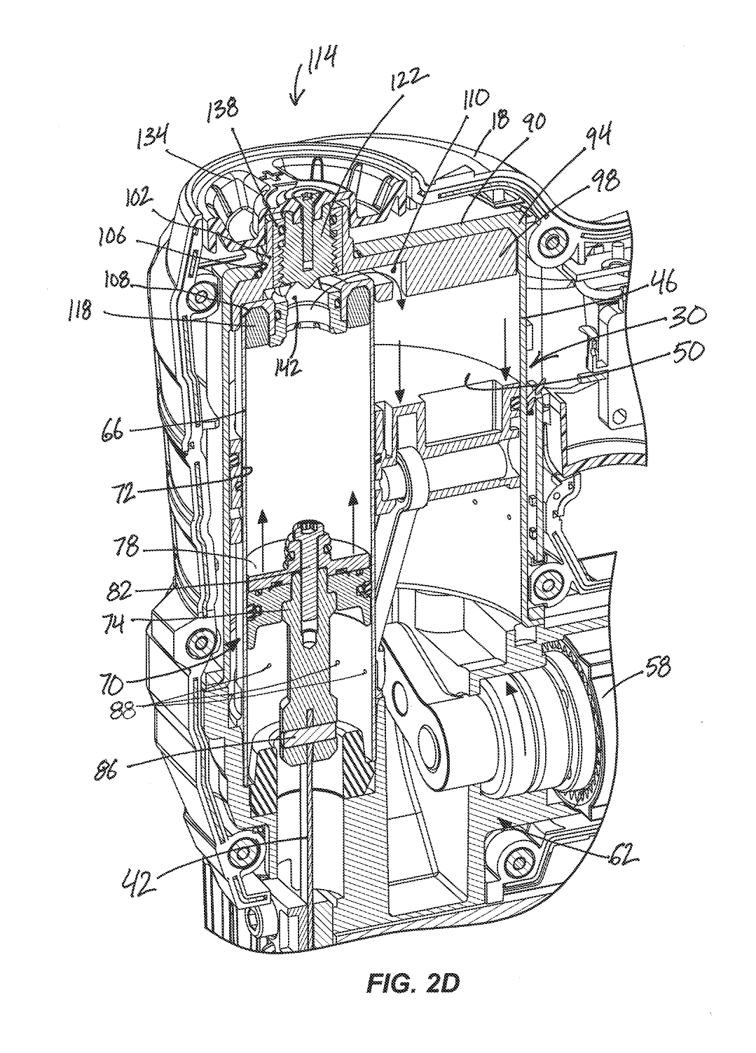

With reference to FIG. 1, a pneumatic fastener driver 10 is operable to drive fasteners (e.g., nails, tacks, staples, etc.) held within a magazine 14 into a workpiece. The pneumatic fastener driver 10 includes an outer housing 18 with a handle portion 22, and a user-actuated trigger 26 mounted on the handle portion 22. The pneumatic fastener driver 10 does not require an external source of air pressure, but rather includes an on-board air compressor 30 (FIG. 2A). The on-board air compressor 30 is powered by a power source (e.g., a battery pack 34), coupled to a battery attachment portion 38 of the outer housing 18.

With reference to FIGS. 2A-2D, the pneumatic fastener driver 10 includes a drive blade 42 actuated by the on-board air compressor 30 to drive the fasteners into a workpiece. The compressor 30 includes a compressor cylinder 46 and a piston 50 in the compressor cylinder 46 driven in a reciprocating manner by a motor 54, a transmission 58, and a crank arm assembly 62. The pneumatic fastener driver 10 also includes a drive cylinder 66 in fluid communication with the compressor cylinder 46 and a drive piston 70 slidably disposed in the drive cylinder 66. As shown in FIG. 2A, the smaller drive cylinder 66 is located inside the larger compressor cylinder 46 for a cylinder-in-a-cylinder configuration. The compressor piston 50 includes a bore 72 through which the drive cylinder 66 extends. The drive piston 70 includes a body 74 and a ferromagnetic cap 78 is secured to the body 74 by a threaded fastener 82. The drive blade 42 is attached to the main body 74 of the drive piston 70 by a pin 86 interference-fit to the main body 74. The drive piston 70 is movable between a top-dead-center position (FIGS. 2A and 2B) and a bottom-dead-center position (FIG. 2C, shown in phantom). The drive cylinder 66 includes a plurality of one-way check valves 88 formed therein to vent excess pressure in the drive cylinder 66 when the drive piston 70 reaches the bottom-dead-center position. Specifically, the check valves 88 are configured as flapper valves that equalize the pressure within the drive cylinder 66 above the drive piston 70 and the pressure within the compressor cylinder 46 below the compressor piston 50 when the valves 88 are uncovered upon the drive piston 70 reaching the bottom-dead-center position. This ensures that there is no excess pressure above the drive piston 70 that would otherwise inhibit the drive piton 70 from being refracted to the top-dead-center position as described in detail below. Similarly, the compressor piston 50 is moveable between a top-dead-center position (FIG. 2C) and a bottom-dead-center position (FIG. 2A).

With continued reference to FIG. 2A, the compressor cylinder 46 includes an integral head 90 formed at a top end 94 of the cylinder 46 (i.e., the head 90 and the cylinder 46 are formed as a single component). The integral compressor cylinder 46 and cylinder head 90 may be manufactured by, for example, a deep-drawing process or an impact extrusion process. The drive cylinder 66 may also be formed using either of the above-mentioned processes with an integral cylinder head.

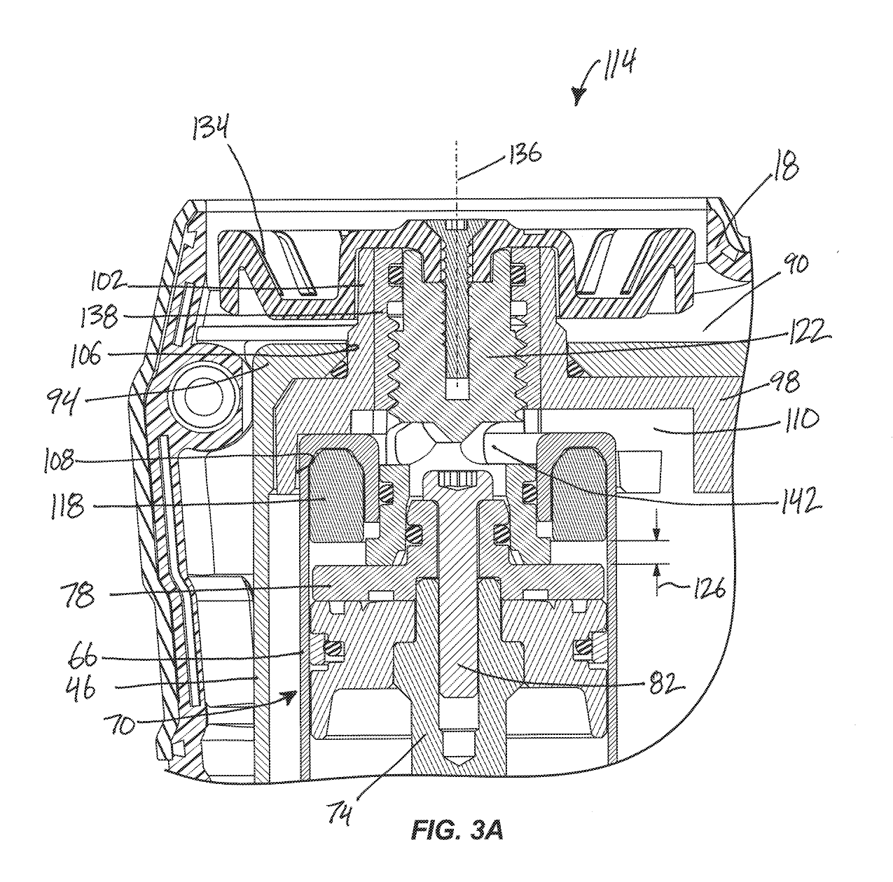

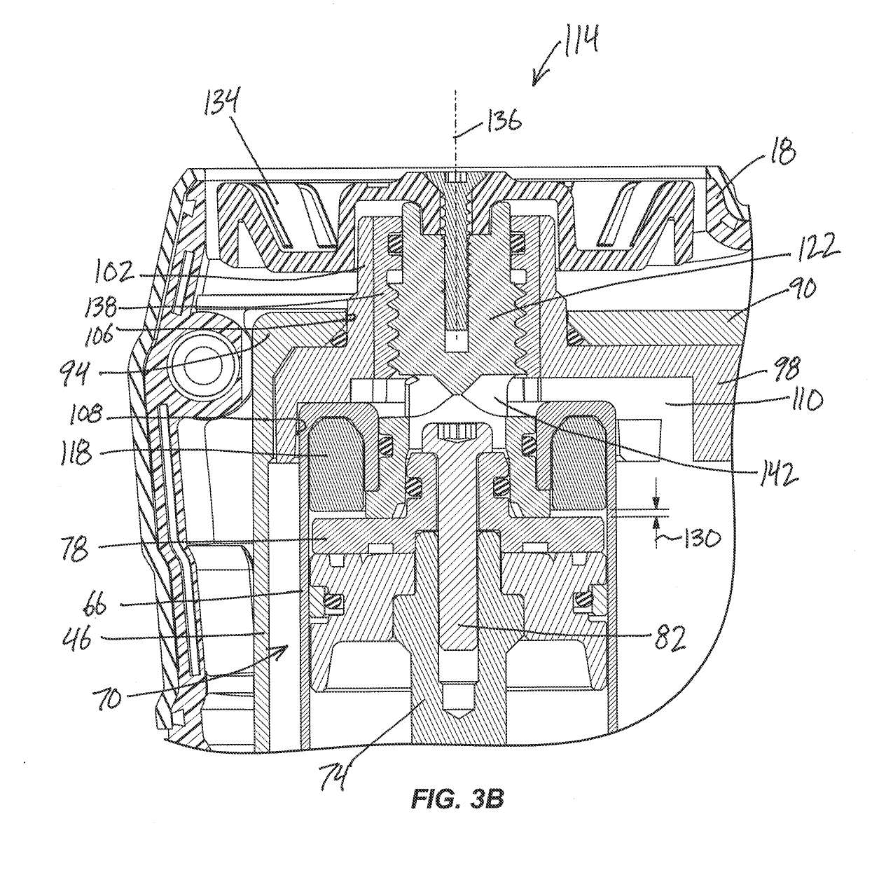

An end cap 98 is positioned within the compressor cylinder 46 adjacent the top end 94 such that a stem portion 102 of the end cap 98 extends through an opening 106 formed in the cylinder head 90. A combination of the opening 106 in the cylinder head 90 and the stem portion 102 of the end cap 94 provides a means to position and align the drive cylinder 66 within the compressor cylinder 46. In addition, a cylindrical recess 108 is formed in the end cap 98 to receive and position the drive cylinder 66 within the compressor cylinder 46. Accordingly, the cylindrical recess 108 in the end cap 98 can further be considered as a feature of the positioning means described above. Alternatively, a boss or any other alignment feature formed on the cylinder head 90 of the compressor cylinder 46 could facilitate positioning and alignment of the drive cylinder 66 within the compressor cylinder 46. The end cap 98 further includes vents 110, only one of which is shown in FIGS. 2A-3B, to enable fluid communication between the compressor cylinder 46 and the drive cylinder 66. Likewise, the cylindrical recess 108 fluidly communicates the compressor cylinder 66 and the drive cylinder 66.

With reference to FIGS. 3A and 3B, the pneumatic fastener driver 10 further includes a magnetic latch 114 capable of holding the drive piston 70 in the top-dead-center position with a magnetic force. The latch 114 includes an annular magnet 118 positioned near the top of the drive cylinder 66. The annular magnet 118 emits a magnetic field that magnetically attracts the ferromagnetic cap 78, which is also a part of the magnetic latch 114. Alternatively, the magnetic latch 114 could include a ferromagnetic portion positioned near the top of the drive cylinder 66 and a magnet secured to the drive piston 70. The magnetic latch 114 also includes a plunger 122 movable between a first position (FIG. 3A) in which a first gap 126 is created between the ferromagnetic cap 78 of the drive piston 70 and the magnet 118 resulting in a first magnetic force acting on the drive piston 70, and a second position (FIG. 3B) in which a second gap 130 smaller than the first gap 126 is created between the ferromagnetic cap 78 of the drive piston 70 and the magnet 118 resulting in a second magnetic force acting on the drive piston 70 larger than the first magnetic force. In the illustrated embodiment of the driver 10, an internally threaded collar 138 is affixed (e.g., via an interference fit or insert-molding process, etc.) within the stem portion 102 of the end cap 98 and the plunger 122 includes external threads engaged with the internal threads of the collar 138. Due to the pitch of the engaged threads of the plunger 122 and collar 138, rotation of the plunger 122 with respect to the threaded collar 138 causes the plunger 122 to translate (i.e., move along a central axis 136) between the first and second positions. Although the threaded collar 138 and the end cap 98 are separate components in the illustrated embodiment of the driver 10, the threaded collar 138 may alternatively be integrally formed as a single piece with the end cap 98.

The magnetic latch 114 further includes an actuator 134 accessible from the top of the outer housing 18 for moving the plunger 122 between the first and second positions. Particularly, rotation of the actuator 134 about the central axis 136 translates the plunger 122 relative to the threaded collar 138, as described in detail above, moving the plunger 122 between the first and second positions. The plunger 122 includes vents 142 exposed or open to the vents 110 formed in the end cap 98 to place the drive cylinder 66 in fluid communication with the compressor cylinder 46.

At the beginning of a fastener driving operation as shown in FIG. 2A, the magnetic latch 114 maintains the drive piston 70 in the top-dead-center position, while the compressor piston 50 is located in the bottom-dead-center position. When the user of the driver 10 depresses the trigger 26, the compressor piston 50 is driven upward and toward the top end 94 of the compressor cylinder 46 by the motor 54 and crank arm assembly 62 (FIG. 2B). As the compressor piston 50 travels upward, the air in the compressor cylinder 46 and above the compressor piston 50 is compressed. Because the top end of the drive cylinder 66 is in fluid communication with the compressor cylinder 46 via the associated vents 142, 110 in the plunger 122 and the end cap 98, respectively, the compressed air also acts upon the drive piston 70. The magnetic latch 144, however, holds or maintains the drive piston 70 in the top-dead-center position shown in FIG. 2B so long as the force of the compressed air acting on the drive piston 70 is less than the magnetic force acting on the drive piston 70 to maintain it in the top-dead-center position.

As the compressor piston 50 approaches the top-dead-center position, the force of the compressed air acting on the drive piston 70 overcomes the magnetic force acting on the drive piston 70, and the drive piston 70 is accelerated downward within the drive cylinder 66 by the compressed air (FIG. 2C). As the drive piston 70 is driven downwards, the drive blade 42 impacts a fastener held in the magazine 14 and drives the fastener into a workpiece until the drive piston 70 reaches the bottom-dead-center position (shown in phantom in FIG. 2C). Upon the drive piston 70 reaching the bottom-dead-center position, any compressed air still acting on the drive piston 70 is vented from the drive cylinder 66 through the check valves 88. Finally, to prepare for a subsequent fastener driving operation, the compressor piston 50 is driven downwards towards the bottom-dead-center position by the motor 54 and crank arm assembly 62 (FIG. 2D). As the compressor piston 50 is driven downward, a vacuum is created within the compressor cylinder 46 and the drive cylinder 66, between the compressor piston 50 and the drive piston 70. The vacuum draws the drive piston 70 upwards in the drive cylinder 66 until the ferromagnetic cap 78 of the drive piston 70 abuts the plunger 122, after which time the magnetic latch 114 again holds or maintains the drive piston 70 in the top-dead-center position.

The magnetic latch 114 may be adjusted to vary the depth to which fasteners are driven into a workpiece. For example, to increase fastener driving depth, the actuator 134 is rotated in one direction to move the plunger 122 upward and toward a top end of the drive cylinder 66 to create a smaller gap 130 (FIG. 3B) between the magnet 118 and the ferromagnetic cap 78, increasing the magnetic force between the magnet 118 and the ferromagnetic cap 78. With the larger magnetic force, a larger compressed air force is needed to overcome the magnetic force and to release the drive piston 70. The larger compressed air force causes the drive piston 70, and subsequent drive blade 42, to drive the fastener deeper into the workpiece. Alternatively, to reduce the driving depth of the fastener, the actuator 134 is rotated in an opposite direction to move the plunger 122 downward and away from the top end of the drive cylinder 66 to create a larger gap 126 (FIG. 3A) between the magnet 118 and ferromagnetic cap 78, decreasing the magnetic force between the magnet 118 and the ferromagnetic cap 78. The lower magnetic force is overcome by a lower compressed air force, resulting in a reduced fastener driving depth.

Various features and advantages of the invention are set forth in the following claims.

What is claimed is:

1. A pneumatic fastener driver comprising:
a cylinder;
a piston positioned within the cylinder and moveable between a top-dead-center position and a bottom-dead-center position; and
a magnetic latch emitting a magnetic field that magnetically attracts the piston and is capable of holding the piston in the top-dead-center position with a magnetic force, wherein the magnetic latch is adjustable to vary the magnetic force acting on the piston for driving fasteners into a workpiece at different depths.

2. The pneumatic fastener driver of claim 1, wherein the magnetic latch includes a magnet emitting the magnetic field and a ferromagnetic portion of the piston.

3. The pneumatic fastener driver of claim 2, wherein the magnet is annular.

4. The pneumatic fastener driver of claim 2, wherein the magnet is positioned adjacent a top end of the cylinder.

5. The pneumatic fastener driver of claim 2, wherein the magnetic latch includes a plunger movable between a first position in which a first gap is created between the ferromagnetic portion of the piston and the magnet resulting in a first magnetic force acting on the piston, and a second position in which a second gap smaller than the first gap is created between the ferromagnetic portion of the piston and the magnet resulting in a second magnetic force acting on the piston larger than the first magnetic force.

6. The pneumatic fastener driver of claim 5, wherein the magnetic latch includes an actuator operable to move the plunger between the first and second positions.

7. The pneumatic fastener driver of claim 6, wherein the plunger is threadably coupled to the cylinder, and wherein the actuator is rotatable for moving the plunger between the first and second positions.

8. The pneumatic fastener driver of claim 6, wherein the piston is displaced from the top-dead-center position to the bottom-dead-center position when the actuator is in the first position and when a force of compressed air acting on the piston exceeds the first magnetic force.

9. The pneumatic fastener driver of claim 6, wherein the piston is displaced from the top-dead-center position to the bottom-dead-center position when the actuator is in the second position and when a force of compressed air acting on the piston exceeds the second magnetic force.

10. The pneumatic fastener driver of claim 1, wherein the piston is a first piston and the cylinder is a first cylinder, and wherein the pneumatic fastener driver further includes
a second cylinder at least partially surrounding the first cylinder and in fluid communication with the first cylinder, and
a second piston positioned within the second cylinder and including a bore through which the first cylinder extends.

11. A pneumatic fastener driver comprising:
a housing;
a cylinder positioned within the housing;
a piston positioned within the cylinder and movable between a top-dead-center position and a bottom-dead-center position; and
a cylinder head integrally formed at a first end of the cylinder as a single component.

12. The pneumatic fastener driver of claim 11, wherein the cylinder and cylinder head are manufactured using one of a deep-drawing process and an impact extrusion process.

13. The pneumatic fastener driver of claim 11, wherein the cylinder is a first cylinder and the piston is a first piston, and wherein the pneumatic fastener driver further includes
a second cylinder positioned within the first cylinder and extending through a bore of the first piston, the second cylinder in fluid communication with the first cylinder, and
a second piston positioned within the second cylinder.

14. The pneumatic fastener driver of claim 13, further comprising means for positioning the second cylinder relative to the first cylinder.

15. A pneumatic fastener driver comprising:
a first cylinder;
a first piston positioned within the first cylinder;
a second cylinder positioned within the first cylinder;
a second piston positioned within the second cylinder; and
means for positioning the second cylinder relative to the first cylinder.

16. The pneumatic fastener driver of claim 15, further comprising
a cylinder head coupled to a first end of the first cylinder; and
an end cap positioned within the first cylinder proximate the first end, wherein the positioning means includes an opening formed in the cylinder head to receive a stem portion of the end cap.

17. The pneumatic fastener driver of claim 16, wherein the positioning means further includes a cylindrical recess formed in the end cap in which the second cylinder is at least partially received.

18. The pneumatic fastener driver of claim 17, wherein the end cap includes vents for fluidly communicating the first cylinder and the second cylinder.

19. The pneumatic fastener driver of claim 18, wherein the vents fluidly communicate the first cylinder and the second cylinder via the cylindrical recess.

20. The pneumatic fastener driver of claim 19, further comprising a plunger positioned within the stem portion of the end cap, wherein the plunger includes vents corresponding to the vents of the end cap for fluidly communicating the first cylinder and the second cylinder.
